(19) United States
(12) Patent Application Publication
(10) Pub. No.: US 2004/0017789 A1
(43) Pub. Date: Jan. 29, 2004

(54) Method for controlling access in a radio communications system

(76) Inventors: Andreas Höynck, (US); Reinhard Köhn, Berlin (DE); Georgios Papoutsis, Berlin (DE); J?uuml;rgen Schindler, Berlin (DE); J?ouml;rg Schniedenharn, Berlin (DE); Jean-Michel Traynard, M?uuml;nchen (DE)

Correspondence Address: STAAS & HALSEY LLP, SUITE 700, 1201 NEW YORK AVENUE, N.W., WASHINGTON, DC, 20005, US

(21) Appl. No.: 10/362,225

(22) PCT Filed: Aug. 21, 2001
(86) PCT No.: PCT/DE01/03183

(30) Foreign Application Priority Data
Aug. 21, 2000 (DE) 10040820.6

(51) Int. Cl. H04Q 7/00

(52) U.S. Cl. 370/329; 370/230

(57) ABSTRACT

Several subscriber stations transmit a respective access sequence to a base station of a radio communications systems on a channel for random access. Afterwards, the radio communications system confirms reception of the access sequences on another channel by a message which selects a subscriber station that can subsequently transmit additional sequences to the base station on a physical access channel.

The invention relates to a method for access control in a radio communications system, in particular in a mobile radio system.

In radio communications systems, information (for example speech, picture information or other data) is transmitted by means of electromagnetic waves via a radio interface between a transmitting and a receiving radio station (base station and mobile station, respectively). The electromagnetic waves are in this case emitted at carrier frequencies which are in the frequency band provided for the respective system. Frequencies in the frequency band around 2000 MHz have been provided for future mobile radio systems which use CDMA or TD/CDMA transmission methods via the radio interface, for example the UMTS (Universal Mobile Telecommunications System) or other third generation systems.

In the case of the GSM mobile radio system by way of example, a time division multiplexing method (TDMA) is used to distinguish between the signal sources, for subscriber separation. One particular embodiment of time division multiplexing (TDMA) is a TDD (time division duplex) transmission method, in which both transmission in the uplink direction, that is to say from the subscriber station to the base station, and transmission in the downlink direction, that is to say from the base station to the subscriber station, take place on a common frequency channel.

The minimum resource unit which can be allocated is governed by the number of bits which can be transmitted in one time slot. The initial access by the subscriber station to physical resources is of major importance in radio communications systems of the described type. Before this registration of the subscriber station in the network, it is impossible for the radio communications system to allocate the subscriber station resources which may be used exclusively by that particular subscriber station. This initial access to the network is therefore implemented using procedures that are on a random basis.

By way of example, it is known from the GSM mobile radio system for a subscriber station to transmit an access block in the uplink direction to a base station in order to request resources. The subscriber station thus signals to the network that it wishes to set up a connection. The time slot which is reserved for the transmission of the access block is in this case accessed on a random basis. If a number of subscriber stations transmit at the same time in this time slot, the access blocks are superimposed, and it may not be possible for the receiving base station to detect them.

After a collision, the subscriber stations once again try to transmit an access block, possibly at an increased transmission power level. The more frequently the access needs to be repeated, the longer is the waiting time, however, and the greater the reduction in the effectiveness of this access method. In relatively modern radio communications systems, such as the TD-SCDMA system, two-stage procedures are used for the initial access. In this case, in a first step, the subscriber station transmits a short data sequence, which the subscriber station selects on a random basis from a predetermined set of data sequences. These short data sequences are also referred to as a signature. When this signature is detected by the receiving base station in the radio communications system, then the network transmits a generally short response on a physical channel which is known to the subscriber station, in order sequentially to allow the subscriber station further access, which then takes place on a physical transmission channel which is likewise known to the subscriber station.

The amount of resources used for the response by the network to the subscriber station should advantageously be chosen to be as small as possible, since, otherwise, these resources will not be available to the system. When no access attempt is being made, these resources thus remain unused. In consequence, if a small amount of resources is provided for the network response and if a large number of access attempts from a number of subscriber stations occur at one particular time, then the network cannot grant access to all these subscriber stations since insufficient physical resources are available for access confirmation. Those subscriber stations which have not been granted access to the system within a specific time will assume that the respective connection request has not been received correctly by the base station and will start the procedure once again, that is to say they will once again select a signature and transmit it to the base station. Such repeat transmissions are normally transmitted at a higher power level, in order to increase the probability of them being received by the base station. These repeat transmissions on the one hand disadvantageously increase the number of connection requests to the system in total, and on the other hand increase the probability of two subscriber stations selecting and transmitting the same signature at the same time, which can result in access collisions and the network not detecting the connection requests.

The invention is thus based on the object of improving the access control efficiency. This object is achieved by the method having the features of patent claim 1. Advantageous developments of the invention can be found in the dependent patent claims.

According to the invention, each response by the network to an access attempt by a subscriber station additionally includes information about the further signatures which have likewise been detected. In this case, for example, only one status bit is advantageously required for each signature in the permitted signature set, which indicates that the network has likewise successfully detected this signature. The response by the network is read by all the subscriber stations which have submitted an access request. On the basis of the information in the message, each subscriber station can determine whether its request was successful. If the subscriber station finds that its access attempt or its transmitted signature has been detected, and if the received acknowledgement message is not for itself, then it knows that it can wait for a message directed to it in one of the subsequent messages. It is thus advantageously possible not to transmit the signature repeatedly. This has a positive effect on the efficiency of the random access procedure, since the number of access attempts is reduced.

Subscriber stations whose signature has not been identified by the network may in contrast make another access attempt very quickly, since they can identify the fact that their connection attempt has failed very soon. Additionally, this advantageously shortens the access duration to the network.

A subscriber station whose signature has been successfully detected but which has still not received a positive response from the network after a specific time may deduce from this that there is no need to increase the power for a repeat transmission, since the first transmission was detected successfully.

Exemplary embodiments of the invention will be explained in more detail with reference to the drawings, in which:

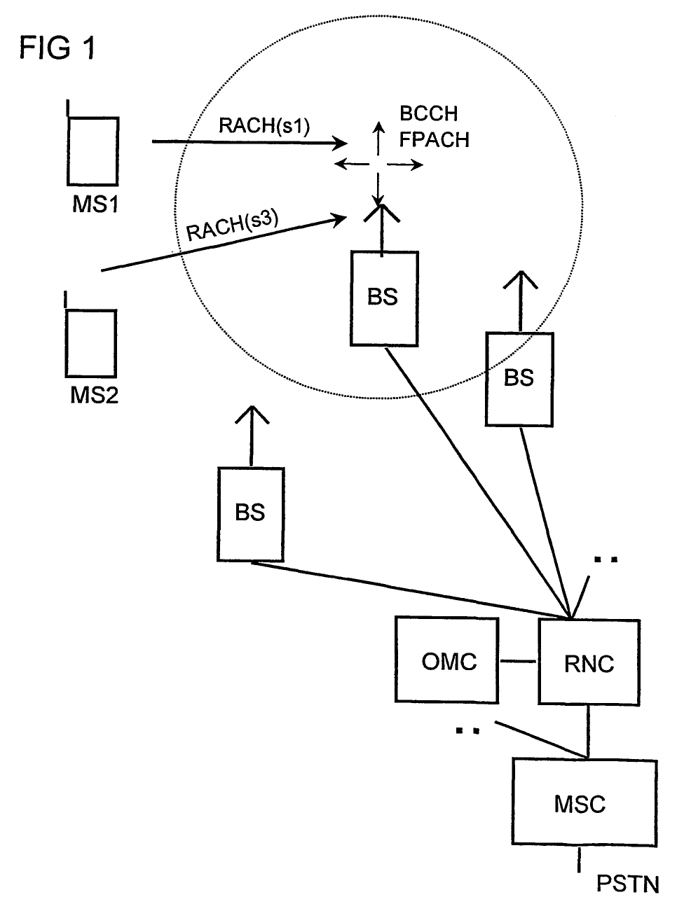

FIG. 1 shows a radio communications system,

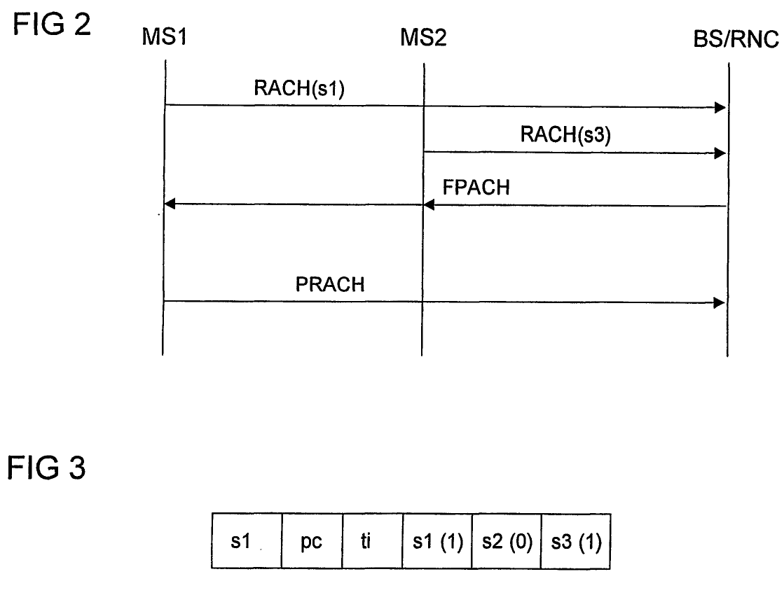

FIG. 2 shows a flowchart of an access control procedure according to the invention, and

FIG. 3 shows a structure of an acknowledgement message.

The mobile radio system which is illustrated in FIG. 1 as an example of a radio communications system has a large number of mobile switching centers MSC, which are networked to one another and allow access to a land line network PSTN. Furthermore, these mobile switching centers MSC are each connected to at least one device RNC (Radio Network Controller) for controlling the base stations BS and for allocating radio resources, that is to say a radio resource manager. Each of these devices RNC in turn allows a connection to at least one base station BS. A base station BS such as this may set up a connection via a radio interface to a subscriber station, for example mobile stations MS, or to other mobile and stationary terminals. Each base station BS supplies radio resources for at least one radio cell.

An operation and maintenance center OMC provides monitoring and maintenance functions for the mobile radio system, or for parts of it. The functionality of this structure can be transferred to other radio communications systems, in which the invention may be used, in particular for subscriber access networks for wire-free subscriber access and for base stations and subscriber stations which are operated in the unlicensed frequency range.

By way of example, FIG. 1 shows connections for transmitting signalling information as point-to-point connections between subscriber stations MS1, MS2 and a base station BS, and an organization channel BCCH (Broadcast Control Channel) as a point-to-multipoint connection. The organization channel BCCH is transmitted at a known constant transmission power level by the base station BS and, inter alia, contains details about the services offered in that radio cell and about the configuration of the channels of the radio interface. A random access channel RACH is offered for the subscriber stations MS1, MS2 in the uplink direction UL.

Based on the exemplary embodiment shown in FIG. 1, the method according to the invention is described on the basis of a flowchart in FIG. 2.

A first subscriber station MS1 selects a first signature s1 from an available set of signatures for an access attempt to the base station BS, or to the network of the radio communications system, and transmits the selected signature s1 in the random access channel RACH to the base station BS. After a short time delay—or at the same time—provided that the network can detect two access attempts parallel—a second subscriber station MS2 selects a further available signature s3, and likewise transmits this in the RACH to the base station BS.

The network, which comprises the base station BS and the RNC, receives the two signatures s1, s3 and evaluates them. The network then uses a physical acknowledgement channel, for example the so-called FPACH (Forward Physical Access Channel) to signal by means of a message to the subscriber station MS1 that this subscriber station can then transmit further messages, which are relevant for the setting up of a connection, to the network on an individual physical channel, for example the so-called PRACH (Physical Random Access Channel). In this case, the addressing process is not direct, but is based on the knowledge of the subscriber stations on which signature they have transmitted to the network.

According to the invention, the network also uses the same message to signal that the further signature s3 has likewise been received from the second subscriber station MS2. As a result of this reception acknowledgement, the second subscriber station MS2 knows that it can expect an access acknowledgement in one of the subsequent messages. This advantageously avoids the second subscriber station MS2 making further access attempts. However, it may do so once a predetermined time interval has elapsed and if no acknowledgement message with the signature s3 has been transmitted by the base station BS within this time period.

If the second subscriber station MS2 notes that the reception of its transmitted signature has not been acknowledged by the network, then, advantageously without any further delay, it makes a further access attempt, since it can assume that the network has not been able to receive the signature. The repeated access may in this case be made, for example, at a higher transmission power level and/or with a different signature being selected.

By way of example, FIG. 3 shows the structure of an acknowledgement message. A first field of the message contains the signature s1, relating to the subscriber station which subsequently wishes to access the individual physical transmission channel. This signature s1 uniquely identifies the selected subscriber station MS1. A second field contains, for example, information about the transmission power level pc (Power control) at which the selected subscriber station MS1 should subsequently transmit. A third field contains, for example, information relating to time control ti (Timing information) or information about a time for transmission. Further fields contain information about the respective status of the signatures s1, s2, s3. This may be signalled, for example, in the form of a bit map. The example in FIG. 3 shows that the signatures s1 and s3 have been received (indicated by a binary 1), with three possible signatures being assumed. In the same way, these fields may also contain only the further received signatures, with the selected signature and the signatures which have not been received not being identified, but in which case they can be associated uniquely by the position in the acknowledgement message.

1. A method for access control in a radio communications system, in which
a number of subscriber stations (MS1, MS2) transmit a respective access sequence (s1, s3) to a base station (BS) in the radio communications system using a random access channel (RACH),
the radio communications system acknowledges reception of the access sequences (s1, s3) by means of a message on a further channel (FPACH), and
in the message, a subscriber station (MS1) is selected, which can then transmit further sequences to the base station (BS) on a physical access channel (PRACH).

2. The method as claimed in claim 1, in which the subscriber station (MS1) is selected by signalling the access sequence (s1).

3. The method as claimed in claim 1 or 2, in which the reception and/or non-reception of the access sequences (s1, s3) is carried out by means of a binary state pointer (1, 0).
